(19) United States
(12) Patent Application Publication
(10) Pub. No.: US 2026/0243291 A1
(43) Pub. Date: Aug. 20, 2026

(54) Self-Drilling Fastener Having Buttress Threads, Hex Flange Head, Angled Shoulder, and Sealing Washer

(71) Applicant: Enstall US, Inc., Hayward, CA (US)

(72) Inventor: Duane Menton, Vallejo, CA (US)

(21) Appl. No.: 19/165,618

(22) PCT Filed: Mar. 27, 2024
(86) PCT No.: PCT/US2024/021640

§ 371 Date: Sep. 16, 2025

Related U.S. Application Data
(60) Provisional application No. 63/454,870, filed on Mar. 27, 2023.

(51) Int. Cl. F16B 25/00; F16B 43/00

(52) U.S. Cl. CPC F16B 25/0073; F16B 43/001

(57) ABSTRACT

A self-drilling fastener for fixing attachments to a roof includes a fastener body having a first end and a second end, a flanged head at the first end having a top, sides perpendicular to the top, and a flange, and a cylindrical shank extending from the head toward the second end and having an angled shoulder, at least one buttress thread, a tapered portion formed at the second end, and a cutting portion formed on the tapered portion. The tapered portion forms a point at the second end and the cutting portion is configured to cut through wood. The self-drilling fastener also includes a sealing washer. The fastener body is configured to fit through an aperture of the washer body and interact with the washer body such that when the fastener is tightened to a structure the flanged head imparts a force on the washer and creates a sealed connection.

### CROSS-REFERENCE TO RELATED APPLICATION

This application claims the benefit of U.S. Provisional Patent Application No. 63/454,870, which was filed Mar. 27, 2023, the disclosure of which is incorporated by reference in its entirety.

### BACKGROUND

### Field of the Disclosure

The present disclosure relates to a self-drilling fastener having buttress threads, a hex flange head, an angled shoulder, and a sealing washer for fixing attachments to a roof, specifically to a rafter or decking, with improved sealing, greater load capacity, increased resistance to stripping and pull out force, easier manufacture, and easier installation.

### Description of Related Art

Fasteners such as screws are well known for their use in construction and building applications for fixing attachments and components to other attachments, components, and structures. The same is true for the construction and building of roofs and for the attachment of components, attachments, and structures, thereto. These roof attachments may include solar modules or components of solar array assemblies in addition to a plethora of other known roof attachments.

Traditional fasteners of this type may include a head and a shank with threading wound around the shank. The head allows for the use of a tool such as a socket or screwdriver to turn the fastener and drive it into a structure. The threading is an inclined plane that protrudes from the shank and acts as a wedge for pushing the fastener deeper into the structure or material to which fastening is desired. Self-tapping fasteners are known to have a shank that tapers to a sharp tip or point which allows the fastener to pierce the surface of the structure the fastener is being driven into. Self-drilling fasteners are also known to include various structures at the tip of the shank that allow the fastener to drill its own hole as it enters a material. This removes the need for pre-drilling holes where a fastener is to be used. Some self-drilling fasteners may have a drilling portion that utilizes features such as a cutting edge or a fluted tip.

A variety of shapes, sizes, and configurations of threading for self-drilling fasteners are also known to have features advantageous for their intended use. For example, with reference to FIGS. 1A-1F, FIGS. 1A-1F show a variety of known thread types. Symmetrical threads such as V threads shown in FIG. 1A, square threads shown in FIG. 1B, Acme threads shown in FIG. 1C, knuckle threads shown in FIG. 1D and Whitworth threads shown in FIG. 1E provide roughly similar tolerances against forces in each direction. Therefore, in a fastener having symmetrical threads, the fastener's tolerance to pulling out of the structure to which it is attached is proportionally similar to the force and torque required to install the fastener. For example, for a fastener with V threads as shown in FIG. 1A, relatively low axial force and torque are required to install the fastener, due to lower friction in the installation direction. However, there is also equally relatively low friction in the opposite direction, and thus the force required to strip out or pull out the fastener is relatively low. For a fastener with square threads as shown in FIG. 1B, higher axial force and torque are required to install the fastener due to higher friction in the installation direction. However, there is also higher friction in the opposite direction, and thus the force required to strip out or pull out the fastener is higher. Thus, symmetrical threads are ideally used in applications that may require equal tolerance to force in each direction. Asymmetrical threads are more advantageous to applications where a higher tolerance to a force is only necessary in one direction. For example, buttress threads as shown in FIG. 1F decreases the friction in the installation direction and thus decreases the force and torque required to install the fastener, while providing higher friction and thus an increased tolerance to pullout or strip out in the opposite direction. This provides for the combination of easier installation, requiring less axial force and torque, while it also provides relatively higher tolerance in the opposite direction and thus increased load capacity against pull out.

In some fastener applications, sealing may be necessary to prevent liquids such as water from entering a structure through the hole created by a fastener. In particular, water proofing is necessary on roofs so that leaks do not occur. Thus, in applications such as the installation of attachments on a roof structure, fasteners may require a sealing feature. It is known that sealing around fasteners such as a roof fasteners may be accomplished by applying roof cement or other sealant. It is also known to provide flashing or a sealing washer for use with the fastener to avoid the mess and difficulty of installation associated with using sealant. However, the use of flashing requires additional installation steps, and known sealing washers are often inadequate for providing proper sealing to a fastener site for a variety of reasons. For instance, fasteners may not be designed or dimensioned for use in an application where water proofing is necessary and where a sealing washer may be utilized. In particular, fasteners are often fully threaded and do not provide an adequate surface to seal against. Additionally, the bottom of fastener heads and fastener shoulders are typically flat or round and do not properly mate with known sealing washers for providing adequate sealing.

Therefore, such currently available fasteners for fixing attachments to a roof suffer from various deficiencies, specifically they do not provide adequate sealing, appropriate load capacity against pullout, easy manufacturing, and easy installation.

In view of the foregoing, there exists a need for a self-drilling fastener for fixing attachments to a roof, specifically to a rafter or decking, with improved sealing, greater load capacity, easier manufacture, and easier installation.

### SUMMARY

Accordingly, aspects of the present disclosure are directed to non-limiting embodiments of a self-drilling fastener for fixing attachments to a roof.

According to non-limiting embodiments, provided is a self-drilling fastener for fixing attachments to a roof, which may include a fastener body which may have a first end and a second end, a flanged head at the first end, and the flanged head may have a top, at least one side perpendicular to the top, and a flange. The fastener body may also have a cylindrical shank extending from the flanged head toward the second end, and the cylindrical shank may have an angled shoulder, at least one buttress thread, a tapered portion formed at the second end, and a cutting portion formed on the tapered portion. The tapered portion may form a point at the second end and the cutting portion may be configured to cut through wood. The fastener may also include a washer. The washer may have a washer body, and the washer body may have an aperture, a top surface, a bottom surface, and a sealing ring made from polymeric material disposed on the bottom surface of the washer body. The cylindrical shank of the fastener body may be configured to fit through the aperture of the washer body and the angled shoulder of the fastener body may be configured to interact with the washer body such that when the fastener is tightened to a structure the flanged head may impart a force on the washer and may create a sealed connection.

According to some non-limiting embodiments, provided is a self-drilling fastener for fixing attachments to a roof, which may include a fastener body which may have a first end and a second end, a flanged head at the first end, and the flanged head may have a top, at least one side perpendicular to the top, and a flange. The fastener body may also have a cylindrical shank extending from the flanged head toward the second end, and the cylindrical shank may have an angled shoulder, at least one buttress thread, a rod portion and a tapered portion integrally formed at the second end, and a cutting portion formed on the rod portion and the tapered portion. The tapered portion may form a point at the second end and the cutting portion may be configured to cut through sheet metal. The washer may have a washer body, and the washer body may have an aperture, a top surface, a bottom surface, and a sealing ring made from polymeric material disposed on the bottom surface of the washer body. The cylindrical shank of the fastener body may be configured to fit through the aperture of the washer body and the angled shoulder of the fastener body may be configured to interact with the washer body such that when the fastener is tightened to a structure the flanged head may impart a force on the washer and may create a sealed connection.

According to some non-limiting embodiments, provided is a fastener which may have a hex head with a flange, an angled shoulder, at least one buttress thread, a self-drilling tip, and a sealing washer having a polymeric seal.

Further embodiments are set forth in the following numbered clauses:
Clause 1: A self-drilling fastener for fixing attachments to a roof, comprising: a fastener body, comprising: a first end and a second end; a flanged head at the first end, having a top, at least one side perpendicular to the top, and a flange; and a cylindrical shank extending from the flanged head toward the second end and having an angled shoulder, at least one buttress thread, a tapered portion formed at the second end, and a cutting portion formed on the tapered portion; wherein the tapered portion forms a point at the second end and the cutting portion is configured to cut through wood, and a washer, comprising: a washer body having an aperture, a top surface, and a bottom surface; and a sealing ring made from polymeric material disposed on the bottom surface of the washer body; wherein the cylindrical shank of the fastener body is configured to fit through the aperture of the washer body and the angled shoulder of the fastener body is configured to interact with the washer body such that when the fastener is tightened to a structure the flanged head imparts a force on the washer and creates a sealed connection.
Clause 2: The fastener of clause 1, wherein the cylindrical shank has two buttress threads.
Clause 3: The fastener of clause 1 or 2, wherein the fastener body and the washer body are manufactured from steel or aluminum.
Clause 4: The fastener of any of clauses 1-3, wherein the polymeric material is ethylene propylene diene terpolymer (EPDM).
Clause 5: The fastener of any of clauses 1-4 wherein the cutting portion of the fastener body is defined by an angle between 60 degrees and 120 degrees and is preferably 90 degrees.
Clause 6: The fastener of any of clause 1-5, wherein the fastener body has a minor diameter between 0.143 inches and 0.159 inches and is preferably 0.151 inches, and a major diameter between 0.238 inches and 0.254 inches and is preferably 0.242 inches.
Clause 7: The fastener of any of clauses 1-6, wherein the fastener body has a pitch between 10 threads per inch and 15 threads per inch and is preferably 13 threads per inch.
Clause 8: The fastener of any of clauses 1-7, wherein the at least one buttress thread has a depth between 0.042 inches and 0.050 inches and is preferably 0.046 inches.
Clause 9: The fastener of any of clauses 1-8, wherein the at least one buttress thread has a first face defined by a first angle between 90 degrees and 110 degrees and is preferably either 93 degrees or 97 degrees, and a second face defined by a second angle between 40 degrees and 70 degrees and is preferably either 45 or 60 degrees.
Clause 10: The fastener of any of clauses 1-9, wherein the fastener body has a pitch between 5 threads per inch and 10 threads per inch and is preferably 6.5 threads per inch.
Clause 11: The fastener of any of clauses 1-10, wherein the angled shoulder is frustoconical.
Clause 12: The fastener of any of clauses 1-11, wherein the angled shoulder tapers from a larger diameter adjacent to the flanged head to a smaller diameter at the at least one buttress thread.
Clause 13: The fastener of any of clauses 1-12, wherein the smaller diameter of the angled shoulder is the same as the minor diameter of the fastener body, and the larger diameter is at least as large as the major diameter of the fastener body.
Clause 14: The fastener of any of clauses 1-13, wherein the sealed connection is between the washer and the structure, and between the washer and the angled shoulder of the fastener.
Clause 15: The fastener of any of clauses 1-14, wherein the cylindrical shank of the fastener body is configured to fit through the aperture of the washer body and the angled shoulder of the fastener body is configured to interact with the washer body such that when the fastener is tightened to a structure the flanged head imparts a force on the top surface of the washer causing the polymeric material of the sealing ring to be compressed thereby reducing a height of sealing ring, increasing an outer diameter of the sealing ring, and reducing an inner diameter of the sealing ring causing the sealing ring to contact the angled shoulder and thereby creating a sealed connection between the sealing ring and the fastener and an attachment or structure the attachment is being fixed to such that the fastening site is water proof.
Clause 16: A self-drilling fastener for fixing attachments to a roof, comprising: a fastener body, comprising: having a first end and a second end; a flanged head at the first end, having a top, at least one side perpendicular to the top, and a flange; and a cylindrical shank extending from the flanged head toward the second end and having an angled shoulder, at least one buttress thread, a rod portion and a tapered portion integrally formed at the second end, and a cutting portion formed on the rod portion and the tapered portion; wherein the tapered portion forms a point at the second end and the cutting portion is configured to cut through sheet metal, and a washer, comprising: a washer body having an aperture, a top surface, and a bottom surface; and a sealing ring made from polymeric material disposed on the bottom surface of the washer body; wherein the cylindrical shank of the fastener body is configured to fit through the aperture of the washer body and the angled shoulder of the fastener body is configured to interact with the washer body such that when the fastener is tightened to a structure the flanged head imparts a force on the washer and creates a sealed connection.
Clause 17: The fastener of clause 16, wherein the cylindrical shank has two buttress threads.
Clause 18: The fastener of clause 16 or 17, wherein the fastener body and the washer body are manufactured from steel or aluminum.
Clause 19: The fastener of any of clauses 16-18, wherein the polymeric material is ethylene propylene diene terpolymer (EPDM).
Clause 20: The fastener of any of clauses 16-19, wherein the angled shoulder is frustoconical.
Clause 21: The fastener of any of clauses 16-20, wherein the angled shoulder tapers from a larger diameter adjacent to the flanged head to a smaller diameter at the at least one buttress thread.
Clause 22: The fastener of any of clauses 16-21, wherein the smaller diameter of the angled shoulder is the same as the minor diameter of the fastener body, and the larger diameter is at least as large as the major diameter of the fastener body.
Clause 23: The fastener of any of clauses 16-22, wherein the sealed connection is between the washer and the structure, and between the washer and the angled shoulder of the fastener.
Clause 24: The fastener of any of clauses 16-23, wherein the cylindrical shank of the fastener body is configured to fit through the aperture of the washer body and the angled shoulder of the fastener body is configured to interact with the washer body such that when the fastener is tightened to a structure the flanged head imparts a force on the top surface of the washer causing the polymeric material of the sealing ring to be compressed thereby reducing a height of sealing ring, increasing an outer diameter of the sealing ring, and reducing an inner diameter of the sealing ring causing the sealing ring to contact the angled shoulder and thereby creating a sealed connection between the sealing ring and the fastener and an attachment or structure the attachment is being fixed to such that the fastening site is water proof.
Clause 25: A fastener, comprising: a hex head with a flange; an angled shoulder; at least one buttress thread; a self-drilling tip; and a sealing washer having a polymeric seal.
Clause 26: The fastener of clause 25, wherein the fastener has two buttress threads.
Clause 27: The fastener of clause 25 or 26, wherein the fastener and the washer are manufactured from steel or aluminum.
Clause 28: The fastener of any of clauses 25-27, wherein the polymeric material is ethylene propylene diene terpolymer (EPDM).
Clause 29: The fastener of any of clauses 25-28, wherein the self-drilling tip is configured to be driven through wood.
Clause 30: The fastener of any of clauses 25-29, wherein the self-drilling tip is configured to be driven through metal.
Clause 31: The fastener of any of clauses 25-30, wherein the angled shoulder is frustoconical.

Further details and advantages of the various examples described in detail herein will become clear upon reviewing the following detailed description of the various examples in conjunction with the accompanying drawing figures.

### BRIEF DESCRIPTION OF THE DRAWINGS

Additional advantages and details are explained in greater detail below with reference to the exemplary embodiments that are illustrated in the accompanying schematic figures, in which:

FIGS. 1A-1E are side profile views of examples of symmetrical thread types known in the prior art;

FIG. 1F is a side profile view of an example of an asymmetrical thread type known in the prior art;

FIGS. 2A-2C are a perspective view, another perspective view, and a side view of a non-limiting embodiment of a fastener in accordance with the present disclosure;

FIGS. 3A-3C are a perspective view, another perspective view, and a side view of a non-limiting embodiment of a fastener body in accordance with the present disclosure;

FIGS. 4A-4B are a top view, and a bottom view of a non-limiting embodiment of a fastener body in accordance with the present disclosure.

FIG. 5 is a side cutout view of a non-limiting embodiment of a second end of a fastener body in accordance with the present disclosure.

FIG. 6 is a side sectional view of a non-limiting embodiment of a fastener body in accordance with the present disclosure.

FIGS. 7A-7C are a perspective, another perspective, and a side view of a non-limiting embodiment of a washer in accordance with the present disclosure;

FIGS. 8A-8C are a perspective view, another perspective view, and a side view of a non-limiting embodiment of a fastener in accordance with the present disclosure;

FIG. 9 is a bottom view of a non-limiting embodiment of a fastener body in accordance with the present disclosure.

FIGS. 10A-10B are cutout side views of a non-limiting embodiment of a second end of a fastener body in accordance with the present disclosure.

Corresponding reference characters indicate corresponding parts throughout the several views. The exemplifications set out herein illustrate exemplary embodiments of the disclosure, and such embodiment are not to be construed as limiting the scope of the disclosure in any manner.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” As used in the specification and the claims, the singular form of “a,” “an,” and “the” include plural referents, such as unless the context clearly dictates otherwise. Additionally, Furthermore, as used herein, the terms “set” and “group” are intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Further, the phrase “based on” is intended to mean “based at least partially on” unless explicitly stated otherwise.

Embodiments of the present disclosure are directed to an improved self-drilling fastener for fixing attachments to a roof, with improved sealing, greater load capacity, increased resistance to stripping and pull out force, easier manufacture, and easier installation. According to non-limiting embodiments, a self-drilling fastener for fixing attachments to a roof may include a fastener body. The fastener body may have a first end and a second end, a flanged head at the first end, and the flanged head may have a top, at least one side perpendicular to the top, and a flange. The fastener body may also have a cylindrical shank extending from the flanged head toward the second end, and the cylindrical shank may have an angled shoulder, at least one buttress thread, a tapered portion formed at the second end, and a cutting portion formed on the tapered portion. The tapered portion may form a point at the second end and the cutting portion may be configured to cut through wood. The fastener may also include a washer. The washer may have a washer body, and the washer body may have an aperture, a top surface, a bottom surface, and a sealing ring made from polymeric material disposed on the bottom surface of the washer body. The cylindrical shank of the fastener body may be configured to fit through the aperture of the washer body and the angled shoulder of the fastener body may be configured to interact with the washer body such that when the fastener is tightened to a structure the flanged head may impart a force on the washer and may create a sealed connection between the washer and the structure, and between the washer and the angled shoulder of the fastener. In some non-limiting embodiments, the cylindrical shank may have two buttress threads. In some non-limiting embodiments, the fastener body and the washer body may be manufactured from steel, aluminum, stainless steel, or another metal or alloy. In some non-limiting embodiments, the polymeric material may be ethylene propylene diene terpolymer (EPDM), or another resilient material such as silicone or neoprene.

In this way, embodiments of the present disclosure allow for fixing attachments to a roof, with improved sealing, greater load capacity, increased resistance to stripping and pull out force, easier manufacture, and easier installation.

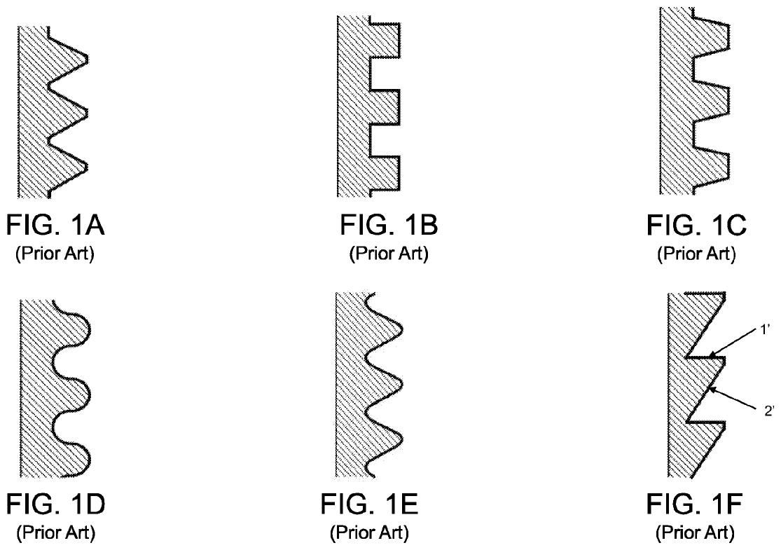

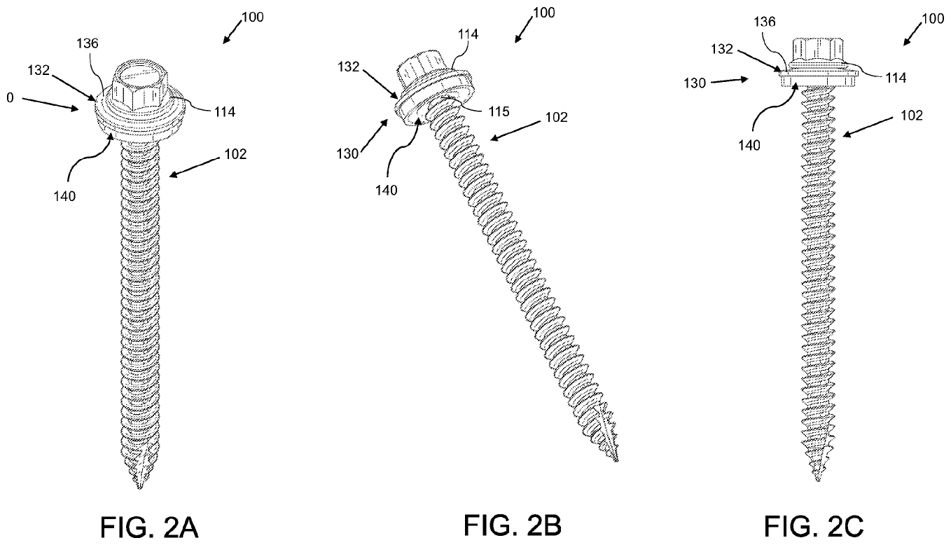

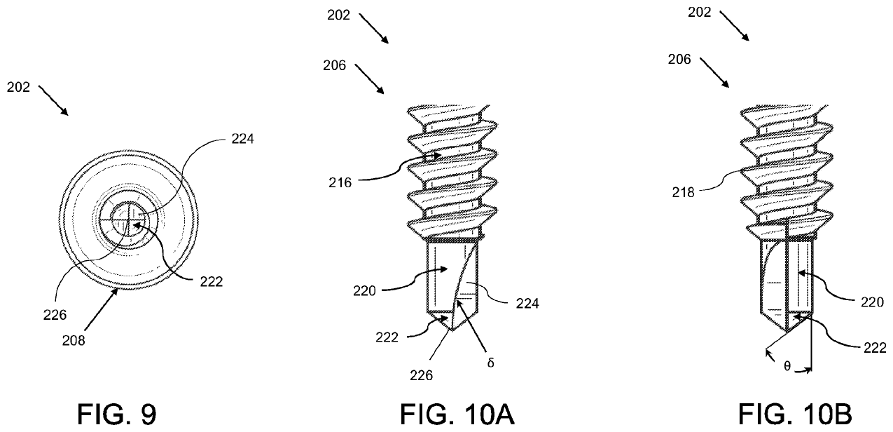

Referring now to FIGS. 1A-1F, FIGS. 1A-1F are side cut-out views of examples of thread types known in the prior art. Symmetrical threading known in the art includes V threads, square threads, Acme threads, knuckle threads, and Whitworth threads as shown in FIGS. 1A-1E, respectively. Asymmetrical threading known in the art includes buttress threads, as shown in FIG. 1F. Fastener 100 and 200 in accordance with the present disclosure and as shown in FIGS. 2A-2C and 9A-9C may include at least one asymmetrical buttress thread. As shown in FIG. 1F, buttress threads may include at least one first face 1′ and at least one second face 2′, and each first face 1′ and second face 2′ may be defined by an angle relative to a central axis.

Referring now to FIGS. 2A-2C, FIGS. 2A-2C are a perspective view, another perspective view, and a side view of a non-limiting embodiment of fastener 100 in accordance with the present disclosure. As shown in FIGS. 2A-2C, fastener 100 may include fastener body 102 and washer 130. FIGS. 2A-2C are discussed in further detail herein below.

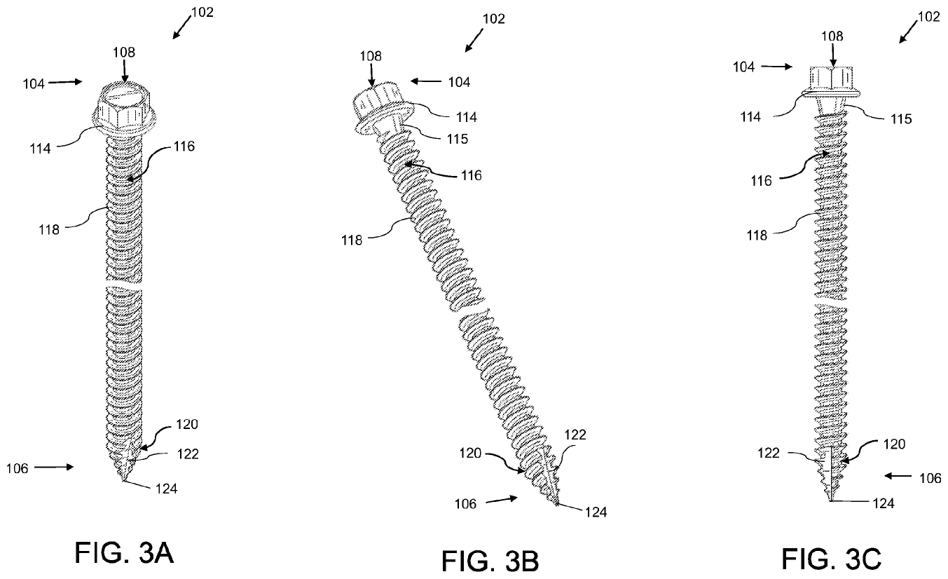

Referring now to FIGS. 3A-3C, FIGS. 3A-3C are a perspective view, another perspective view, and a side view of a non-limiting embodiment of fastener body 102 of fastener 100 in accordance with the present disclosure. As shown in FIGS. 3A-3C, fastener body 102 may have first end 104, second end 106 and flanged head 108 at first end 104. Flanged head 108 may include top 110 and at least one side perpendicular to top 110. Flanged head 108 may further include flange 114, as shown in FIGS. 3A-3C. As further shown in FIGS. 3A-3C, fastener body 102 may include cylindrical shank 116 and cylindrical shank 116 may extend from a bottom surface of flanged head 108 at first end 104 of fastener body 102 to second end 106 of fastener body 102. Cylindrical shank may include angled shoulder 115 and angled shoulder 115 may be frustoconical. Cylindrical shank 116 may also include at least one buttress thread 118, as described above. Angled shoulder 115 may taper from a larger diameter adjacent to flanged head 108 to a smaller diameter at buttress thread 118. The smaller diameter of angled shoulder 115 may be the same as the minor diameter A of fastener body 102 (discussed below with reference to FIG. 5), and the larger diameter may be as large as or larger than the major diameter B of fastener body 102 (discussed below with reference to FIG. 5). In some non-limiting embodiments, cylindrical shank 116 may include two buttress threads. As further shown in FIGS. 3A-3C, cylindrical shank 116 may include tapered portion 120 at second end 106 of fastener body 102 and tapered portion 120 may include cutting portion 122 formed on tapered portion 120. Tapered portion 120 may form point 124 at second end 106 of fastener body 102. Cutting portion 122 may be configured to cut through wood and allow fastener body 102 and fastener 100 to drill through wood without the need to pre-drill holes at a fastening site. In some non-limiting embodiments, fastener body 102 may be manufactured from steel, aluminum, stainless steel, or another metal or alloy.

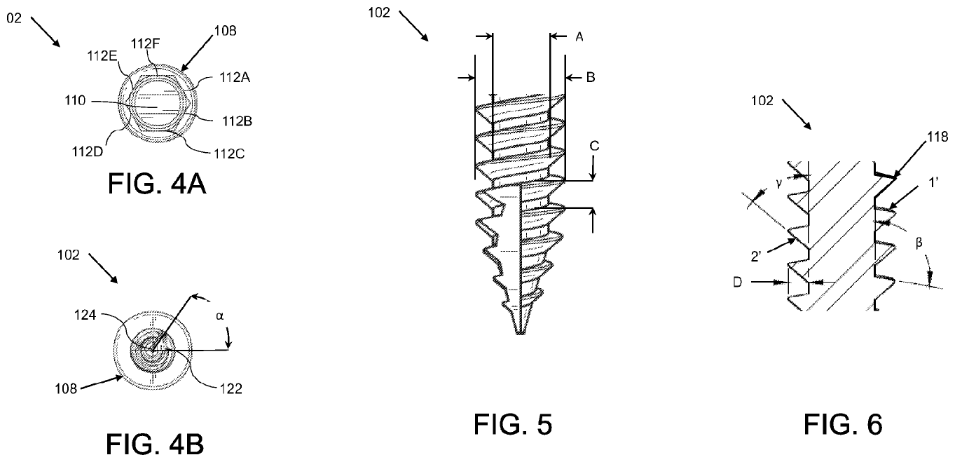

Referring now to FIGS. 4A-4B, FIGS. 4A-4B are a top view, and a bottom view of a non-limiting embodiment of fastener body 102 in accordance with the present disclosure. As shown in FIG. 4A, flanged head 108 may include top 110 and six sides 112A-112F perpendicular to top 110. In some non-limiting embodiments, flanged head 108 may have six sides and may be a hex-head, configured to interact with a screwdriver, socket, wrench or other tool for driving fastener 100. As shown in FIG. 4B, cutting portion 122 of fastener body 102 may be defined by angle α. Angle α may be between 60 and 120 degrees, and may preferably be 90 degrees.

Referring now to FIGS. 5 and 6, FIG. 5 is a side cutout view of a non-limiting embodiment of a second end of fastener body 102 in accordance with the present disclosure and FIG. 6 is a side sectional view of a non-limiting embodiment of a fastener body in accordance with the present disclosure. In some non-limiting embodiments, as shown in FIG. 5, fastener body 102 may have minor diameter A, and minor diameter A may be between 0.143 inches, and 0.159 inches and may preferably be 0.151 inches. Minor diameter A may be the same as the diameter of cylindrical shank 116. In some non-limiting embodiments, fastener body 102 may further have major diameter B and major diameter B may be between 0.238 inches and 0.254 inches, and may preferably be 0.242 inches. In some non-limiting embodiments, fastener body 102 may further have pitch C and pitch C may be between 10 threads per inch and 15 threads per inch, and may preferably be 13 threads per inch. In some non-limiting embodiments, fastener body 102 may have two buttress threads. In embodiments having two buttress threads, pitch C may be between 5 threads per inch and 10 threads per inch, and preferably may be 6.5 threads per inch. As shown in FIG. 6, fastener body 102 may have buttress thread 118 and buttress thread 118 may have thread depth D. In some non-limiting embodiments, thread depth D may be between 0.042 inches and 0.050 inches, and may preferably be 0.046 inches. As further shown in FIG. 6, buttress thread 118 may be characterized by angle β of face 1′ and by angle γ of face 2′. In some non-limiting embodiments, angle β may be between 90 degrees and 110 degrees, and may preferably be 97 degrees or 93 degrees. In some non-limiting embodiments, angle γ may be between 40 degrees and 70 degrees, and may preferably be 45 degrees or 60 degrees.

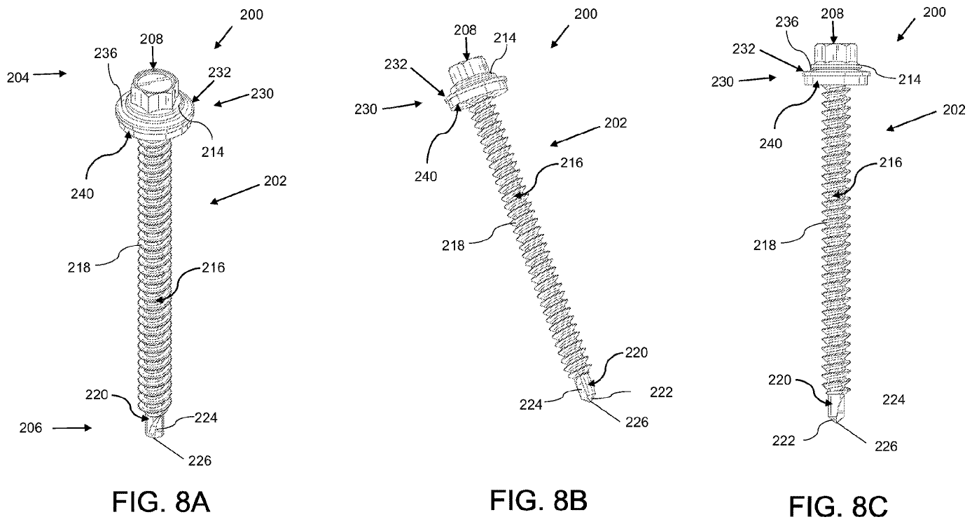

In some non-limiting embodiments, fastener body 102 may be dimensioned according to the intended use of fastener 100. It is to be understood that the dimensions provided above for dimensions A, B, C, and D are for exemplary purposes only and are not to be construed as limiting the present disclosure, as fastener body 102 and thus fastener 100 may be manufactured in any number of sizes. It is to be further understood that other non-limiting embodiments of a fastener body such as fastener body 202 (FIGS. 8A-10B) may also have dimensions A, B, C, and D, and/or may alternatively have different dimensions.

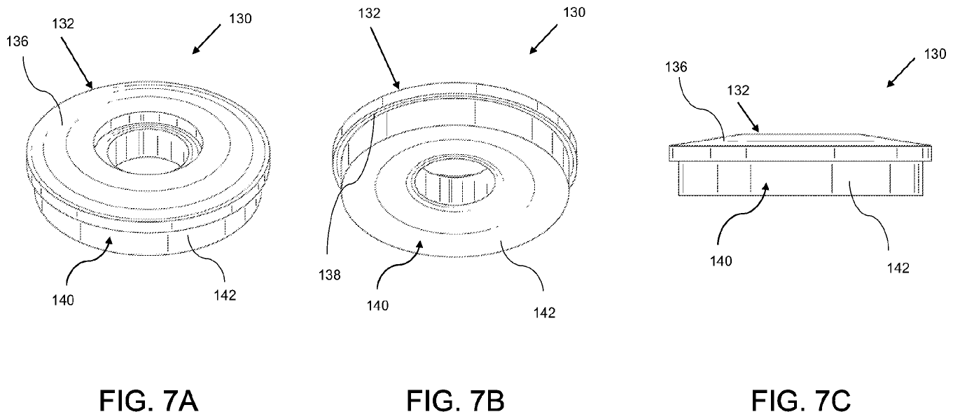

Referring now to FIGS. 7A-7C, FIGS. 7A-7C are a perspective, another perspective, and a side view of a non-limiting embodiment of washer 130 of fastener 100 in accordance with the present disclosure. As show in FIGS. 7A-7C, washer 130 may include washer body 132 and washer body 132 may have aperture 134, top surface 136 and bottom surface 138. In some non-limiting embodiments, washer body 132 may be manufactured from steel, aluminum, stainless steel, or another metal or alloy. As further shown in FIGS. 7A-7C, washer 130 may further include sealing ring 140 and sealing ring 140 may be made of polymeric material 142. In some non-limiting embodiments, polymeric material 140 may be ethylene propylene diene terpolymer (EPDM), or another resilient material such as silicone or neoprene.

Referring again to FIGS. 2A-2C and 3A-3C, cylindrical shank 116 of fastener body 102 may be configured to fit through an aperture of washer body 132. Angled shoulder 115 of fastener body 102 may be configured to interact with washer body 132, such that when fastener 100 is tightened to a structure, flanged head 108 imparts a force on top surface 136 of washer 130 causing polymeric material 142 of sealing ring 140 to be compressed, thereby reducing a height of sealing ring 140, increasing an outer diameter of sealing ring 140, and reducing an inner diameter of sealing ring 140. This compression and flattening may causing sealing ring 140 to contact angled shoulder 115, thereby creating a sealed connection between sealing ring 140, fastener 100 and an attachment or structure the attachment is being fixed to, such that the fastening site is water proof.

Referring now to FIGS. 8A-8C, FIGS. 8A-8C are a perspective view, another perspective view, and a side view of a second non-limiting embodiment of fastener 200 in accordance with the present disclosure. Fastener 200 and components thereof may be the same or similar to fastener 100. As shown in FIGS. 9A-9C, fastener 200 may include fastener body 202 and washer 230. Fastener body 202 may include flanged head 208 and cylindrical shank 216. Cylindrical shank 216 may extend from a bottom surface of flanged head 208 at a first end of fastener body 202 to a second end of fastener body 202. Cylindrical shank 216 may include at least one buttress thread 218.

Referring now to FIG. 9 and FIGS. 10A-10B, FIG. 9 is a bottom view of a non-limiting embodiment of a fastener body in accordance with the present disclosure and FIGS. 10A-10B are cutout side views of a non-limiting embodiment of a second end of a fastener body in accordance with the present disclosure. As shown in FIGS. 8A-8C, 9 and 10A-10B, cylindrical shank 216 may include rod portion 220 at second end 206 of fastener body 202. Cylindrical shank 216 may further include tapered portion 222 integrally formed with rod portion 220 at second end 206 of fastener body 202. Tapered portion 222 may form point 226 at second end 206 of fastener body 202. Fastener body 202 may further include cutting portion 224 formed on rod portion 220 and tapered portion 222. Cutting portion 224 may be configured to cut through sheet metal and allow fastener body 202 and fastener 200 to drill through sheet metal without the need to pre-drill holes at a fastening site. In some non-limiting embodiments, the diameter of rod portion 220 and cutting portion 224 may be substantially the same as or preferably marginally larger than the diameter of cylindrical shank 216.

Referring again to FIGS. 8A-8C, cylindrical shank 216 of fastener body 202 may be configured to fit through an aperture of washer body 232 of washer 230. An angled shoulder (not shown) of fastener body 202 may be configured to interact with washer body 232, such that when fastener 200 is tightened to a structure, flanged head 208 imparts a force on washer 230 and creates a sealed connection between fastener 200 and an attachment or structure the attachment is being fixed. For example, an angled shoulder of fastener body 202 may be configured to interact with washer body 232, such that when fastener 200 is tightened to a structure, flanged head 208 imparts a force on top surface 236 of washer 230 causing the polymeric material of sealing ring 240 to be compressed, thereby reducing a height of sealing ring 240, increasing an outer diameter of sealing ring 240, and reducing an inner diameter of sealing ring 240. This compression and flattening may causing sealing ring 240 to contact the angled shoulder of fastener body 202, thereby creating a sealed connection between sealing ring 240, fastener 200 and an attachment or structure the attachment is being fixed to, such that the fastening site is water proof.

While several examples of a self-drilling fastener for fixing attachments to a roof and the components and materials thereof are shown in the accompanying figures and described in detail hereinabove, other aspects will be apparent to, and readily made by, those skilled in the art without departing from the scope and spirit of the disclosure. Accordingly, the foregoing description is intended to be illustrative rather than restrictive. The invention described hereinabove is defined by the appended claims and all changes to the invention that fall within the meaning and range of equivalency of the claims are to be embraced within their scope.

### DESCRIPTION OF REFERENCE SIGNS

1′: First face
2′: Second face
100: Fastener
102: Fastener body
104: First end of fastener body
106: Second end of fastener body
108: Flanged head of fastener body
110: Top of flanged head
112A-F: Sides of flanged head
114: Flange
115: Angled Shoulder
116: Cylindrical shank
118: Buttress thread
120: Tapered portion
122: Cutting portion
124: Point
130: Washer
132: Washer body
134: Aperture
136: Top surface of washer body
138: Bottom surface of washer body
140: Sealing ring
142: Polymeric material
200: Fastener
202: Fastener body
204: First end of fastener body
206: Second end of fastener body
208: Flanged head of fastener body
214: Flange
216: Cylindrical shank
218: Buttress thread
220: Rod Portion
222: Tapered portion
224: Cutting portion
226: Point
230: Washer
232: Washer body
236: Top surface of washer body
240: Sealing ring
α: Angle of cutting portion
β: Angle of first face
γ: Angle of second face
θ: Angle of taper
A: Minor diameter
B: Major diameter
C: Pitch
D: Depth

1. A self-drilling fastener for fixing attachments to a roof, comprising:
a fastener body, comprising:
a first end and a second end;
a flanged head at the first end, having a top, at least one side perpendicular to the top, and a flange; and
a cylindrical shank extending from the flanged head toward the second end and having an angled shoulder, at least one buttress thread, a tapered portion formed at the second end, and a cutting portion formed on the tapered portion;
wherein the tapered portion forms a point at the second end and the cutting portion is configured to cut through wood, and a washer, comprising:
a washer body having an aperture, a top surface, and a bottom surface; and
a sealing ring made from polymeric material disposed on the bottom surface of the washer body;
wherein the cylindrical shank of the fastener body is configured to fit through the aperture of the washer body and the angled shoulder of the fastener body is configured to interact with the washer body such that when the fastener is tightened to a structure the flanged head imparts a force on the washer and creates a sealed connection.

2. The fastener of claim 1, wherein the cylindrical shank has two buttress threads.

3. (canceled)

4. (canceled)

5. The fastener of claim 1, wherein the cutting portion of the fastener body is defined by an angle between 60 degrees and 120 degrees and is preferably 90 degrees.

6. The fastener of claim 1, wherein the fastener body has a minor diameter between 0.143 inches and 0.159 inches and is preferably 0.151 inches, and a major diameter between 0.238 inches and 0.254 inches and is preferably 0.242 inches.

7. The fastener of claim 1, wherein the fastener body has a pitch between 10 threads per inch and 15 threads per inch and is preferably 13 threads per inch.

8. The fastener of claim 1, wherein the at least one buttress thread has a depth between 0.042 inches and 0.050 inches and is preferably 0.046 inches.

9. The fastener of claim 1, wherein the at least one buttress thread has a first face defined by a first angle between 90 degrees and 110 degrees and is preferably either 93 degrees or 97 degrees, and a second face defined by a second angle between 40 degrees and 70 degrees and is preferably either 45 or 60 degrees.

10. The fastener of claim 2, wherein the fastener body has a pitch between 5 threads per inch and 10 threads per inch and is preferably 6.5 threads per inch.

11. The fastener of claim 1, wherein the angled shoulder is frustoconical.

12. (canceled)

13. (canceled)

14. The fastener of claim 1, wherein the sealed connection is between the washer and the structure, and between the washer and the angled shoulder of the fastener.

15. The fastener of claim 1, wherein the cylindrical shank of the fastener body is configured to fit through the aperture of the washer body and the angled shoulder of the fastener body is configured to interact with the washer body such that when the fastener is tightened to a structure the flanged head imparts a force on the top surface of the washer causing the polymeric material of the sealing ring to be compressed thereby reducing a height of sealing ring, increasing an outer diameter of the sealing ring, and reducing an inner diameter of the sealing ring causing the sealing ring to contact the angled shoulder and thereby creating a sealed connection between the sealing ring and the fastener and an attachment or structure the attachment is being fixed to such that the fastening site is water proof.

16. A self-drilling fastener for fixing attachments to a roof, comprising:
a fastener body, comprising:
a first end and a second end;
a flanged head at the first end, having a top, at least one side perpendicular to the top, and a flange; and
a cylindrical shank extending from the flanged head toward the second end and having an angled shoulder, at least one buttress thread, a rod portion and a tapered portion integrally formed at the second end, and a cutting portion formed on the rod portion and the tapered portion;
wherein the tapered portion forms a point at the second end and the cutting portion is configured to cut through sheet metal, and
a washer, comprising:
a washer body having an aperture, a top surface, and a bottom surface; and
a sealing ring made from polymeric material disposed on the bottom surface of the washer body;
wherein the cylindrical shank of the fastener body is configured to fit through the aperture of the washer body and the angled shoulder of the fastener body is configured to interact with the washer body such that when the fastener is tightened to a structure the flanged head imparts a force on the washer and creates a sealed connection.

17. The fastener of claim 16, wherein the cylindrical shank has two buttress threads.

18. The fastener of claim 16, wherein the fastener body and the washer body are manufactured from steel or aluminum.

19. (canceled)

20. (canceled)

21. The fastener of claim 16, wherein the angled shoulder tapers from a larger diameter adjacent to the flanged head to a smaller diameter at the at least one buttress thread.

22. (canceled)

23. The fastener of claim 16, wherein the sealed connection is between the washer and the structure, and between the washer and the angled shoulder of the fastener.

24. The fastener of claim 16, wherein the cylindrical shank of the fastener body is configured to fit through the aperture of the washer body and the angled shoulder of the fastener body is configured to interact with the washer body such that when the fastener is tightened to a structure the flanged head imparts a force on the top surface of the washer causing the polymeric material of the sealing ring to be compressed thereby reducing a height of sealing ring, increasing an outer diameter of the sealing ring, and reducing an inner diameter of the sealing ring causing the sealing ring to contact the angled shoulder and thereby creating a sealed connection between the sealing ring and the fastener and an attachment or structure the attachment is being fixed to such that the fastening site is water proof.

25. A fastener, comprising:
a hex head with a flange;
an angled shoulder;
at least one buttress thread;
a self-drilling tip; and
a sealing washer having a polymeric seal.

26. The fastener of claim 25, wherein the fastener has two buttress threads.

27-30. (canceled)

31. The fastener of claim 25, wherein the angled shoulder is frustoconical.
